(19) United States
(12) Patent Application Publication
(10) Pub. No.: US 2012/0163788 A1
(43) Pub. Date: Jun. 28, 2012

(54) Stereoscopic Imaging Device

(75) Inventors: Takashi Masuno, Osaka (JP); Tatsuro Juri, Osaka (JP); Hiroaki Shimazaki, Osaka (JP); Kenjiro Tsuda, Kyoto (JP); Yuji Nagaishi, Osaka (JP)

(73) Assignee: PANASONIC CORPORATION, Osaka (JP)

(21) Appl. No.: 13/338,257

(22) Filed: Dec. 28, 2011

(30) Foreign Application Priority Data
Dec. 28, 2010 (JP) 2010-294048
Dec. 1, 2011 (JP) 2011-264009

(51) Int. Cl. G03B 35/00

(52) U.S. Cl. 396/325

(57) ABSTRACT

Stereoscopic imaging device that can take stereo images with the parallax between the left and right eyes being accurately established is afforded. The stereoscopic imaging device (11) includes: an optical branching device having an incident surface (35), a beam-splitter part (33) that splits light from the incident surface into two directions, an extension part (36), and a reflection part (38) that reflects at least a portion of the light bent by the beam splitter part (33) and bends the reflected light in the y-axis positive direction; a first camera (31) that takes left-eye images; and a second camera (32) that takes right-eye images. The respective optical axes of the optical system of the first camera (31) and of the optical system of the second camera (32) are parallel to the y-axis.

### CROSS REFERENCE TO RELATED APPLICATION

The disclosures of Japanese Patent Application No.2010-294048, filed on Dec. 28, 2010 and Japanese Patent Application No.2011-264009, filed on Dec. 1, 2011 are incorporated herein by reference.

### BACKGROUND OF THE INVENTION

1. Field of the Invention

The present invention relates to a stereoscopic imaging device used to take stereo images with two cameras.

2. Description of the Background Art

In order to photograph stereo images, to date a stereoscopic imaging device 900 as shown in FIG. 11 has at times been used. The stereoscopic imaging device 900 includes a left-eye camera 910, a right-eye camera 920, and a semi-reflective mirror 930. The semi-reflective mirror 930 passes one portion of light incident on the mirror and reflects the remaining portion. The left-eye camera 910 shoots the optical image having passed through the semi-reflective mirror 930, and the right-eye camera 920 shoots the optical image having been reflected by the semi-reflective mirror 930. Furthermore, the left-eye camera 910 can move in the direction perpendicular to the drawing sheet. The stereo base between the left-eye camera 910 and the right-eye camera 920 is thereby changed to adjust the left-eye and right-eye parallaxes.

With the increasingly widespread use of video equipment that can play 3-D video, demand for imaging devices that can take stereoscopic images has grown considerably, wherein there is a need for compact stereoscopic imaging devices that are easy to carry and handle. One conceivable example of a method for making stereoscopic imaging devices compact is to employ household cameras as left-eye and right-eye cameras to configure a stereoscopic imaging device as shown, e.g., in FIG. 9.

However, the configuration represented in FIG. 9, which uses a semi-reflective mirror, poses a problem, in that the overall size of the stereoscopic imaging device proves to be large.

Other than this, prior art relating to the present application is disclosed in Japanese Laid-Open Patent Publication No. 2004-312545.

### SUMMARY OF THE INVENTION

Therefore, an object of the present invention is to make available a downsized stereoscopic imaging device.

A stereoscopic imaging device according to the present invention includes: a beam splitter portion including an incident surface of a rectangle having a long side extending in a first direction and a short side extending in a second direction, and an optically functional surface that passes a part of light emitted from the incident surface in a third direction orthogonal to the incident surface, and that reflects a remaining part of the light emitted from the incident surface to bend the reflected light into the second direction; an extension portion that is formed of a material having a higher refractive index than a refractive index of air and that further passes the light having passed through the optically functional surface; a reflection portion that is formed of a material having a higher refractive index than the refractive index of air and that further bends the light reflected by the optically functional surface in the third direction orthogonal to the incident surface by means of a reflecting surface provided therein; a first camera that takes an optical image having passed through the extension portion; and a second camera that takes an optical image having been reflected by the reflecting surface and having passed through the reflection portion.

When the stereoscopic imaging device of the present invention is used, the optical axis directions of the two cameras coincide with each other. Therefore, it is possible to cause behaviors of the optical systems in the cameras to coincide with each other, and thus, it is possible to take a stereo image with the parallax amount between the left eye and the right eye accurately set.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a stereoscopic imaging device according to a first embodiment of the present invention;

FIG. 2 is a side view of the stereoscopic imaging device shown in FIG. 1;

FIG. 3 is an optical path diagram illustrating an advantage of the stereoscopic imaging device according to the first embodiment of the present invention;

FIG. 4 is a perspective view of a stereoscopic imaging device according to a second embodiment of the present invention;

FIG. 5 is a perspective view of the stereoscopic imaging device according to the second embodiment of the present invention;

FIG. 6A is a perspective view of an optical branching device according to a fourth embodiment of the present invention;

FIG. 6B is a side view of the optical branching device shown in FIG. 6A;

FIG. 7A is a perspective view of an optical branching device according to a fifth embodiment of the present invention;

FIG. 7B is a side view of the optical branching device shown in FIG. 7A;

FIG. 8A is a perspective view of an optical branching device according to a sixth embodiment of the present invention;

FIG. 8B is a side view of the optical branching device shown in FIG. 8A; and

FIG. 9 is a side view of a conventional stereoscopic imaging device.

### DESCRIPTION OF THE PREFERRED EMBODIMENTS

### First Embodiment

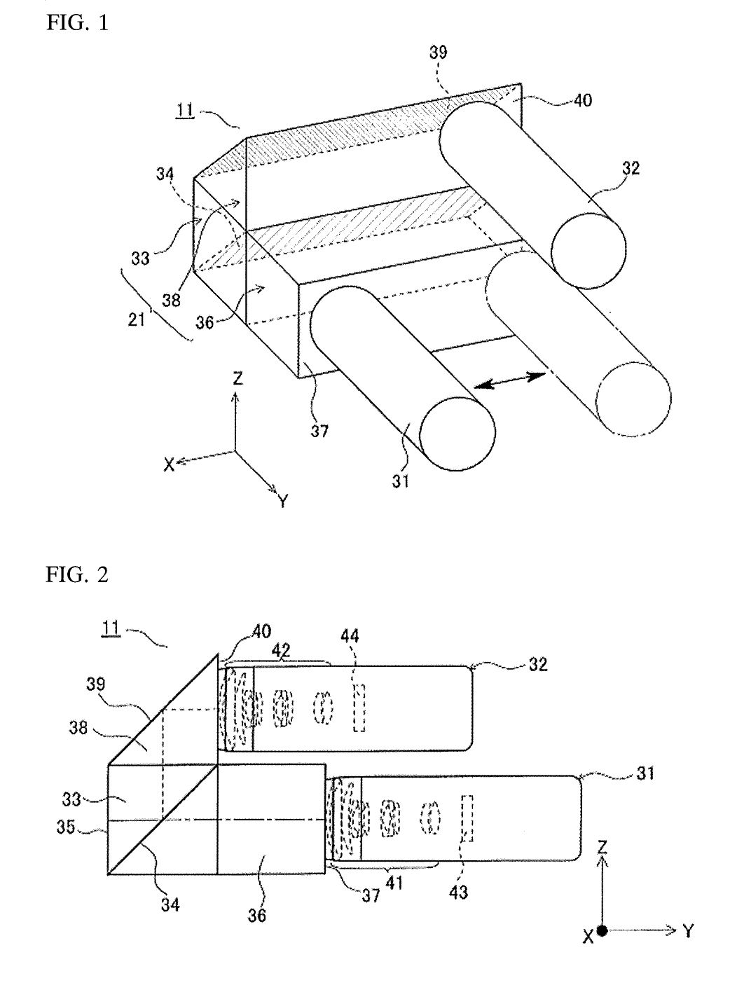

FIG. 1 is a perspective view of a stereoscopic imaging device according to a first embodiment of the present invention, and FIG. 2 is a side view of the stereoscopic imaging device shown in FIG. 1. Hereinafter, the direction in which a long side of an incident surface of a beam-splitter part extends is defined as an X-axis direction, and the direction in which a short side thereof extends is defined as a Z-axis direction.

A stereoscopic imaging device 11 is configured to take a stereo image, and includes an optical branching device 21 which splits light into two directions, a first camera 31 which takes an optical image for a left eye, and a second camera 32 which takes an optical image for a right eye. Each of the first camera 31 and the second camera 32 is arranged such that an optical axis of an optical system thereof is parallel to the Y-axis (that is, orthogonal to an incident surface 35).

The optical branching device 21 splits light incident thereon into two directions. The optical branching device 21 includes: a beam-splitter part 33 which splits light emitted from the incident surface 35 into two directions; an extension part 36 arranged between the beam-splitter part 33 and the first camera 31; and a reflection part 38 which reflects, by a reflecting surface thereof, light bent by the beam-splitter part 33 and which leads the reflected optical image to the second camera 32.

The beam-splitter part 33 is a rectangular parallelepiped prism beam splitter. The beam-splitter part 33 includes an optically functional surface 34 provided therein, and a rectangle incident surface 35 on which light is incident. The optically functional surface 34 is provided within the beam-splitter part 33, so as to have an exact angle of 45 degrees relative to the incident surface 35. The optically functional surface 34 is a semi-reflective mirror and passes a part of the incident light from the incident surface 35 and reflects the remaining part of the incident light in the Z-axis positive direction. The beam-splitter part 33 is prepared by putting together inclined surfaces of right-angled prisms whose bottom surfaces are right-angled isosceles triangles. Since the lateral surfaces of the right-angled prisms are precisely figured by being polished, after the inclined surfaces are put together, a rectangular parallelepiped prism beam splitter is formed in which adjacent lateral surfaces are exactly orthogonal with one another. Moreover, each inclined surface has been subjected to metal vapor deposition, and thus, when the beam-splitter part 33 is prepared, these metal vapor deposition surfaces function as a semi-reflective mirror.

The extension part 36 is provided between the beam-splitter part 33 and the first camera 31. The extension part 36 is formed of the same material, in the same shape, and with the same size as those of the beam-splitter part 33, and includes a first light exit surface 37 which is parallel to the XZ plane (plane including the incident surface 35). Light having passed through the beam-splitter part 33 passes through the inside of the extension part 36, and is emitted from the first light exit surface 37. It should be noted that the extension part 36 is formed of a material having a higher refractive index than that of air, such as glass or resins. The extension part 36 is precisely figured by being polished, and is bonded to the beam-splitter part 33 so as to contact, without any gap, a surface facing the incident surface 35 of the beam-splitter part 33.

The reflection part 38 is configured to lead a part of light reflected by the beam-splitter part 33 to the second camera 32, and includes a reflecting surface 39 which reflects a part of the light reflected by the beam-splitter part 33, and a second light exit surface 40 which is parallel to the XZ plane. Here, the reflection part 38 is a right-angled prism whose bottom surface is a right-angled isosceles triangle. The size in the X-axis direction, the size in the Y-axis direction, and the size in the Z-axis direction of the reflection part 38 are the same as those of the beam-splitter part 33, respectively. The reflection part 38 is mounted on the top surface of the beam-splitter part 33 with the inclined surface of the right-angled prism oriented diagonally upward and with the second light exit surface 40 oriented in the Y-axis positive direction. A part of the light reflected by the optically functional surface 34 is bent in the X-axis positive direction by the reflecting surface 39, and then emitted from the second light exit surface 40. Although the reflection part 38 is formed of a material having a higher refractive index than that of air, such as glass or resins, it is preferable that the reflection part 38 is formed of a material having the same refractive index as that of the extension part 36. Here, the reflection part 38 is precisely figured by being polished, and contacts, without any gap, the top surface of the beam-splitter part 33.

As shown in FIG. 2, the length of the optical path, from the optically functional surface 34 to the first light exit surface 37, on the optical axis of the optical system of the first camera 31 (indicated by chain line) is equal to the length of the optical path, from the optically functional surface 34 to the second light exit surface 40, on the optical axis of the optical system of the second camera 32 (indicated by broken line).

The first camera 31 includes an optical system 41 for forming an optical image, and an image sensor 43 which converts the optical image formed by the optical system 41 into an electric signal. The first camera 31 is arranged with the optical axis of the optical system 41 coinciding with the Y-axis direction and with the optical system 41 facing the first light exit surface 37. The first camera 31 is supported so as to be movable in the X-axis direction along the first light exit surface 37, from the position indicated by solid lines to the position indicated by change lines in FIG. 1, while keeping the optical axis of the first camera 31 orthogonal to the incident surface 35. Accordingly, it is possible to change the stereo base in the X-axis direction between the first camera 31 and the second camera 32, and to adjust the parallax amount between the left eye and the right eye.

Similarly to the first camera 31, the second camera 32 includes an optical system 42 and an image sensor 44. The second camera 32 captures the optical image bent by the optically functional surface 34 and the reflecting surface 39. Here, the second camera 32 is fixed to the reflection part 38 with the optical axis of the optical system 42 coinciding with the Y-axis direction and with the optical system 42 facing the second light exit surface 40. Accordingly, the light emitted from the second light exit surface 40 directly enters the optical system 42. It should be noted that instead of moving the first camera 31, the first camera 31 may be fixed and only the second camera 32 may be moved in the X-axis direction. Alternatively, both of the first camera 31 and the second camera 32 may be configured to be movable in the X-axis direction.

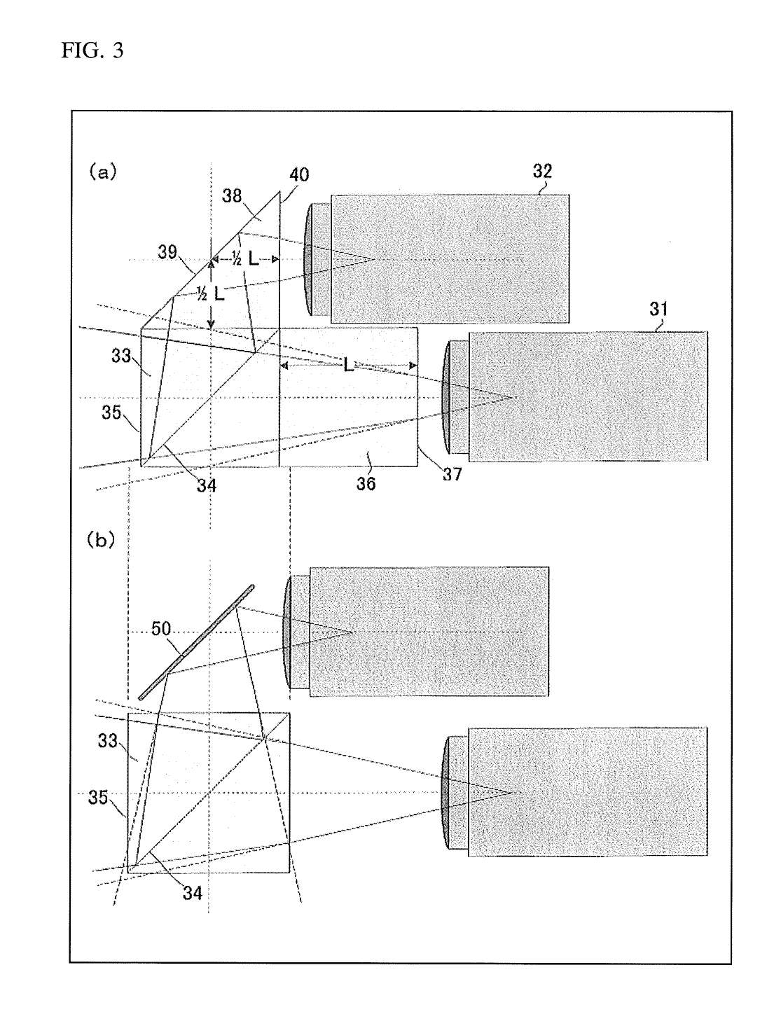

FIG. 3 is an optical path diagram illustrating an advantage of the stereoscopic imaging device according to the first embodiment of the present invention. More specifically, FIG. 3(a) is an optical path diagram of the stereoscopic imaging device according to the present embodiment, and FIG. 3(b) is an optical path diagram of a stereoscopic imaging device according to a sixth embodiment described later. Each of FIGS. 3(a) and (b) shows optical paths at the maximum view angle in solid lines, when the view angles of the cameras are set to an identical angle.

In the present embodiment, the extension part 36 formed of a material having a higher refractive index than the refractive index of air is provided in the optical path between the beam-splitter part 33 and the first camera 31. The light having passed through the optically functional surface 34 and having been emitted from the beam-splitter part 33 enters the extension part 36, passes through the inside of the extension part 36, is emitted from the first light exit surface 37, and enters the first camera 31. Similarly, the light having been reflected by the optically functional surface 34 and emitted from the beam-splitter part 33 enters the reflection part 38, is reflected inside the reflection part 38 by the reflecting surface 39, then passes through the second light exit surface 40, and enters the second camera 32.

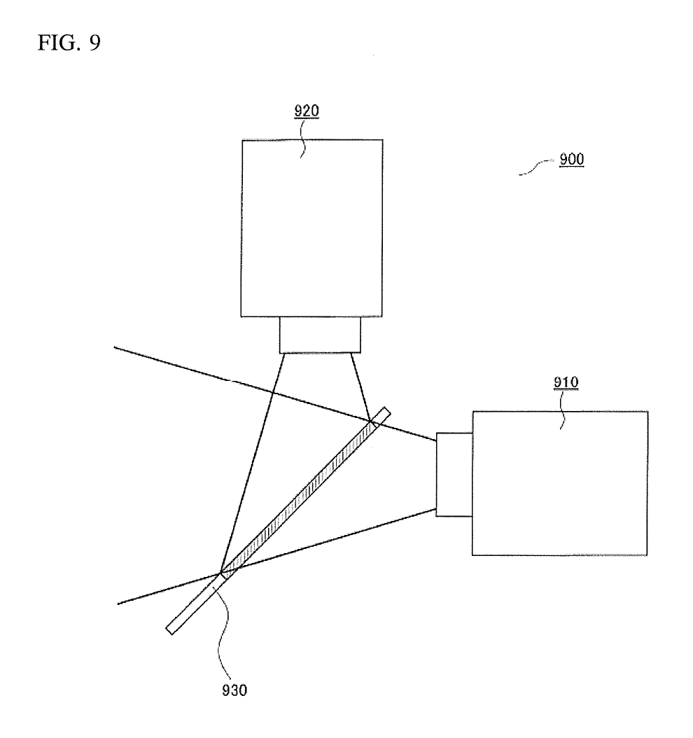

As shown in FIGS. 3(a) and (b), when the beam-splitter part 33 is used, the optical path in the medium having a higher refractive index than that of air becomes longer compared with that in the conventional example shown in FIG. 9. Accordingly, the overall size of the stereoscopic imaging device can be reduced. Moreover, according to the configuration shown in FIG. 3(a), by using the extension part 36 and the reflection part 38, the optical path in the medium having a higher refractive index than that of air becomes longer compared with that in the configuration shown in FIG. 3(b). Accordingly, the optical path advancing in the air can be reduced. Therefore, according to the present embodiment, the size of the beam-splitter part 33 can further be reduced.

Moreover, the first camera 31 and the second camera 32 are arranged in parallel with each other such that their optical axes are parallel to the Y-axis. Hereinafter, description will be given of advantages of the arrangement in which the optical axes of the two cameras are arranged in parallel to each other and orthogonal to a plane including the incident surface 35.

In a lens barrel used in a household camera, a lens holding frame and a drive mechanism are less accurately assembled, compared with a camera for professional use. Thus, strictly speaking, a displacement occurs in a lens drive section or in the lens holding frame. Therefore, as shown in FIG. 9, if one of a camera for a left eye and a camera for a right eye is arranged so as to be perpendicular to the ground, the amount of positional displacement in the lens drive section or in the lens holding frame become different from that in the other camera, causing displacement in optical axes of the left and the right cameras.

Meanwhile, inside a camera, an initial setting operation of the lens drive section and the like is performed at the time of activation of the system. This operation is designed assuming that the camera is held in a substantially horizontal manner. In a case where one of the cameras is arranged perpendicular to the ground and the other camera is arranged horizontally relative to the ground as shown in FIG. 9, different gravity influences are applied on movable portions, such as lens drive section, resulting in different optical accuracies in the respective cameras after the initial settings are performed.

For these reasons, in the case of a stereoscopic imaging device in which a camera is arranged perpendicular to the ground, displacement in the left and right optical axes is also caused by differences in arrangement accuracies of the optical systems and in driving controls, and thus, it is difficult to take a stereo image of high accuracy.

Therefore, in the present invention, in order to realize a stereoscopic imaging device that can take a stereo image of high accuracy, each of the optical axis of the first camera 31 and the optical axis of the second camera 32 is arranged so as to be parallel to the Y-axis. As a result, the initial setting operations of the lens drive sections and the like at the time of activation of the systems are performed in the same state. Moreover, since the first camera 31 and the second camera 32 are orientated in the same direction, even if positional displacements have occurred in the lens drive section and the lens holding portion in the first camera 31 and the second camera 32, the characteristics of the positional displacements (the direction and the degree of the displacement) will be substantially the same. Therefore, displacements of optical axes due to the arrangement of the cameras do not occur, and thus, it is possible to take a stereo image with the parallax amount accurately set. Moreover, the parallel arrangement of the first camera and the second camera has an advantage in that it contributes downsizing of the stereoscopic imaging device. Moreover, by providing the extension part 36 and the reflection part 38 formed of a material whose refractive index is higher than that of air, it is possible to reduce the length of the optical paths from the incident surface 35 to the incident surfaces of the cameras. As a result, the size in the optical axis direction of the stereoscopic imaging device can be reduced.

### Second Embodiment

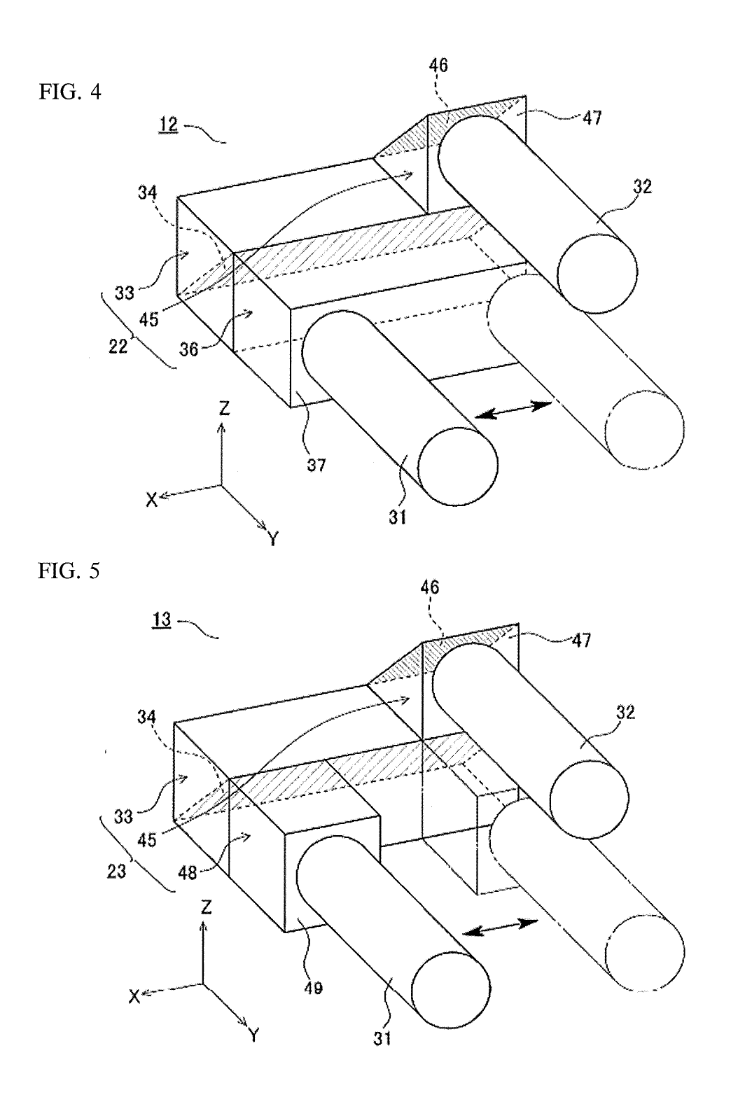

FIG. 4 is a perspective view of a stereoscopic imaging device according to a second embodiment of the present invention. A stereoscopic imaging device 12 according to the second embodiment is different from the stereoscopic imaging device 11 according to the first embodiment, in that the size of a reflection part 45 is different.

The reflection part 45 according to the present embodiment is smaller in size in the X-axis direction than the reflection part 38 according to the first embodiment. More specifically, the size in the X-axis direction of the reflection part 45 is smaller than the size in the X-axis direction of the beam-splitter part 33 and is greater than the imaging area in the X-axis direction of the second camera 32. Here “the size of the reflection part is greater than the imaging area of a camera” means that the size of the reflection part is greater than the diameter of a light beam advancing within the view angle of the optical system of the camera. Since the stereoscopic imaging device 12 according to the second embodiment allows reduction of the size of the reflection part 45 compared with that of the first embodiment, the stereoscopic imaging device 12 advantageously leads to reduction of production costs and of the weight of the stereoscopic imaging device.

### Third Embodiment

FIG. 5 is a perspective view of a stereoscopic imaging device according to a third embodiment of the present invention. A stereoscopic imaging device 13 according to the third embodiment is different from the imaging device 12 according to the second embodiment, in that the size of an extension part 48 is different.

The extension part 48 according to the present embodiment is smaller in size in the X-axis direction than the extension part 36 according to the second embodiment. More specifically, the size in the X-axis direction of the extension part 48 is smaller than the size in the X-axis direction of the beam-splitter part 33 and is greater than the imaging area in the X-axis direction of the first camera 31. The first camera 31 is fixed to the extension part 48, and the first camera 31 and the extension part 48 are integrally movable in the X-axis direction from the position indicated by solid lines to the position indicated by chain lines in FIG. 5. Accordingly, it is possible to change the stereo base between the first camera 31 and the second camera 32, and to adjust the parallax amount between the left eye and the right eye. Since the stereoscopic imaging device 13 according to the third embodiment allows reduction of the size of the extension part 48 in addition to that of the reflection part 45, it is possible to further reduce the production costs and the weight of the stereoscopic imaging device.

### Fourth Embodiment

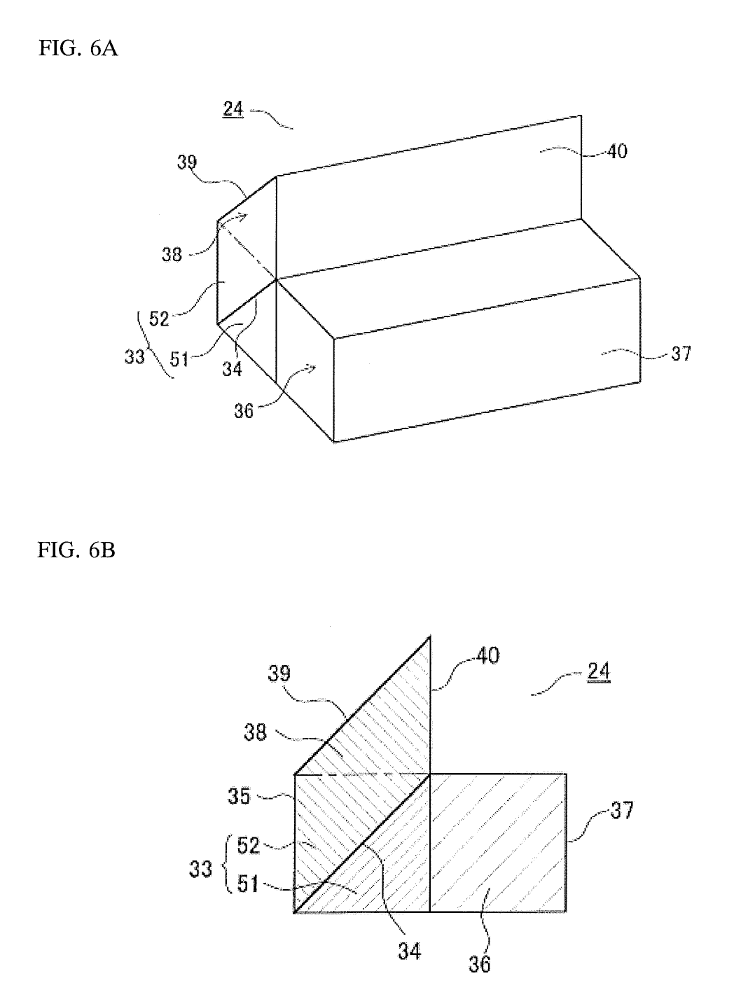

FIG. 6A is a perspective view of an optical branching device according to a fourth embodiment of the present invention, and FIG. 6B is a side view of the optical branching device shown in FIG. 6A. An optical branching device 24 according to the fourth embodiment is different from the optical branching device 21 according to the first embodiment, in that the number of divisions into which the optical branching device is divided is different.

The beam-splitter part 33 includes a first portion 52 which is on the incident surface 35 side relative to the optically functional surface 34; and a second portion 51 which is on the extension part 36 side relative to the optically functional surface 34. In the fourth embodiment, the first portion 52 is formed integrally with the reflection part 38. Thus, in the fourth embodiment, by reducing the number of divisions of the optical branching device 24, it is possible to reduce the number of portions at which division bodies are bonded together, which facilitates exact determination of the positional relationship among the incident surface 35, the reflecting surface 39, the optically functional surface 34, the first light exit surface 37, and the second light exit surface 40.

### Fifth Embodiment

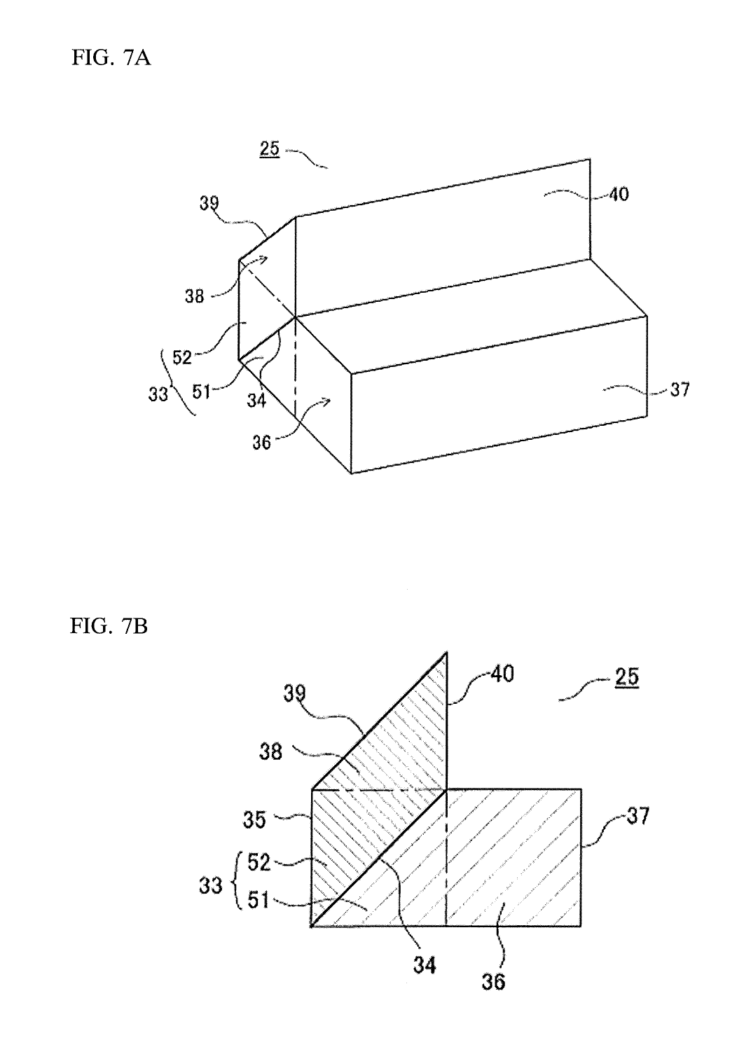

FIG. 7A is a perspective view of an optical branching device according to a fifth embodiment of the present invention, and FIG. 7B is a side view of the optical branching device shown in FIG. 7A. An optical branching device 25 according to the fifth embodiment is different from the optical branching device 21 according to the first embodiment, in that the number of divisions into which the optical branching device is divided is different.

In the fifth embodiment, the first portion 51 is formed integrally with the extension part 36, and further, the second portion 52 is formed integrally with the reflection part 38. Thus, in the fifth embodiment, by reducing the number of divisions of the optical branching device, it is possible to reduce the number of portions at which the division bodies are bonded together, which facilitates exact determination of the positional relationship among the incident surface 35, the reflecting surface 39, the optically functional surface 34, the first light exit surface 37, and the second light exit surface 40.

### Sixth Embodiment

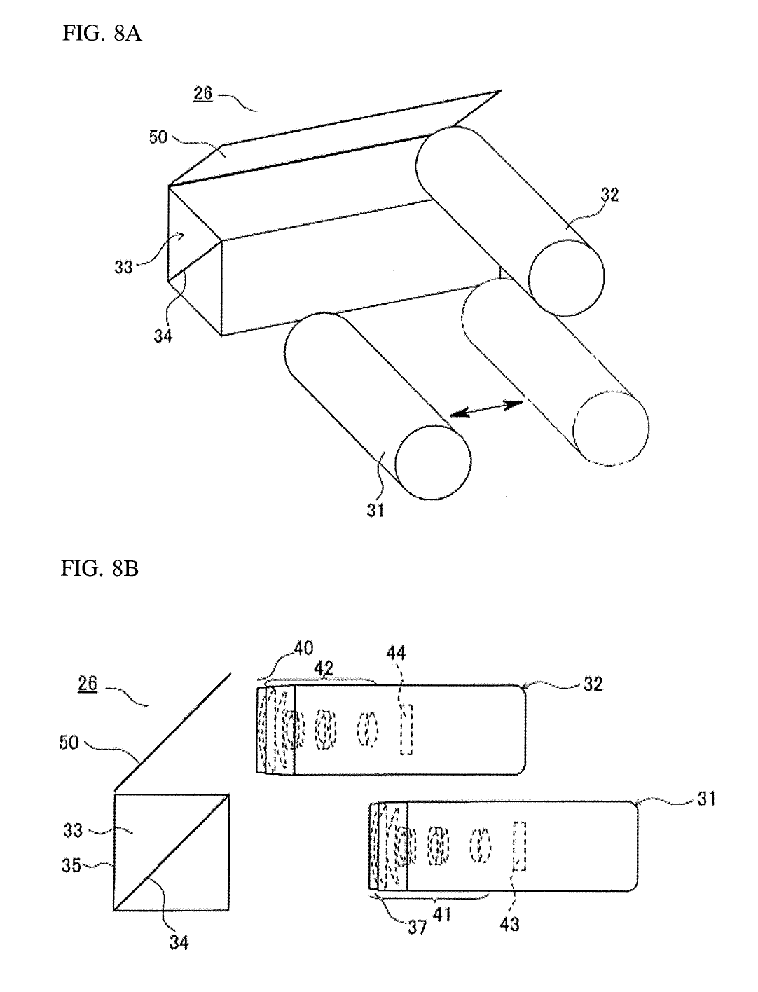

FIG. 8A is a perspective view of an optical branching device according to a sixth embodiment of the present invention, and FIG. 8B is a side view of the optical branching device shown in FIG. 8A. An optical branching device 26 according to the sixth embodiment is different from the optical branching device 21 according to the first embodiment, in that a reflection part 50 is formed of a mirror. Moreover, the optical branching device 26 is not provided with a member corresponding to the extension part 36 according to the first embodiment.

Even when a simple configuration is employed of the optical branching device 26, which is implemented as a combination of a beam splitter and a mirror as shown in FIGS. 8A and 8B, the first camera 31 can be arranged in parallel to the second camera 32, and thus, a similar effect to that of the first embodiment can be achieved.

### Other Modifications

In the first to the third embodiments, the first camera contacts the first light exit surface of the extension part and the second camera contacts the second light exit surface of the reflection part. However, the positional relationship is not limited thereto. For example, the first and the second cameras may be supported, being spaced from the extension part and the reflection part, respectively.

Further, in the first and the third embodiments, the size in the Y-axis direction of the beam-splitter part may be different from the size in the Y-axis direction of the extension part. Similarly, the size in the Y-axis direction of the beam-splitter part may be different from the size in the Y-axis direction of the reflection part.

Further, in the first and the third embodiments, the extension part is provided between the beam-splitter part and the first camera. However, an optical branching device composed of the beam-splitter part and the reflection part, without the extension part, may be configured.

In the second and the third embodiments, the beam-splitter part, the reflection part, and the extension part are implemented as separate components, respectively. However, similarly to the fourth and the fifth embodiments, a part of the beam-splitter part may be formed integrally with the reflection part, or a part of the beam-splitter part may be formed integrally with the extension part.

In each embodiment described above, the first camera takes an image for a left eye and the second camera takes an image for a right eye. However, the left-right positional relationship between the first camera and the second camera may be reversed.

Moreover, in the first to the fifth embodiments, it is preferable that the refractive index of the material of the extension part is identical with the refractive index of the material of the reflection part. However, these may be different from each other. When the refractive index of the material of the extension part is different from the refractive index of the material of the reflection part, the sizes of the extension part and the reflection part may be changed to cause the lengths of the optical paths of the light entering the two cameras to be identical with each other. Alternatively, by zooming adjustment of one of the cameras, the view angles of the two cameras may be adjusted to be identical with each other.

The present invention may be used, for example, in a stereoscopic imaging device for taking a stereo image.

Details of the present invention have been described above. However, the above-mentioned description is completely illustrative from every point of view, and does not limit the scope of the present invention. Obviously, various improvements and modifications can be performed without departing from the scope of the present invention.

What is claimed is:

1. A stereoscopic imaging device comprising:
a beam-splitter part including
an incident surface in the form of a rectangle having longer sides extending in a first direction and shorter sides extending in a second direction, and
an optically functional surface that passes a portion of light emitted from the incident surface in a third direction, orthogonal to the incident surface, and that, reflecting a remaining portion of the light emitted from the incident surface, bends the reflected light into the second direction;
an extension part formed of a material having a higher refractive index than the refractive index of air and that further passes light having passed through the optically functional surface;
a reflection part formed of a material having a higher refractive index than the refractive index of air and having an internal reflecting surface that bends light reflected by the optically functional surface further, in the third direction orthogonal to the incident surface;
a first camera for taking an optical image having passed through the extension part; and
a second camera for taking an optical image having been reflected by the reflecting surface and having passed through the reflection part.

2. The stereoscopic imaging device according to claim 1, wherein:
the extension part includes a first light-exit surface parallel to the incident surface; and
the reflection part includes a second light-exit surface parallel to a plane including the incident surface.

3. The stereoscopic imaging device according to claim 2, wherein the dimension of the extension part in said first direction is smaller than the dimension of the beam-splitter part in said first direction, and is greater than an imaging range of the first camera in the same direction.

4. The stereoscopic imaging device according to claim 3, wherein:
the first camera is fixed to the extension part; and
the first camera and the extension part are unitarily movable in said first direction.

5. The stereoscopic imaging device according to claim 2, wherein the dimension of the extension part in said first direction is equal to the dimension of the beam-splitter part in said first direction.

6. The stereoscopic imaging device according to claim 5, wherein the first camera is shiftable in said first direction, paralleling the first light-exit surface of the extension part.

7. The stereoscopic imaging device according to claim 2, wherein the dimension of the reflection part in said first direction is smaller than the dimension of the beam-splitter part in said first direction, and is greater than an imaging range of the second camera in the same direction.

8. The stereoscopic imaging device according to claim 2, wherein the dimension of the reflection part in said first direction is equal to the dimension of the beam-splitter part in said first direction.

9. The stereoscopic imaging device according to claim 2, wherein:
the beam-splitter part is divided into a first portion to the incident-surface side of the optically functional surface, and a second portion to the extension-part side of the optically functional surface; and
the extension part is formed integrally with said first portion.

10. The stereoscopic imaging device according to claim 2, wherein:
the beam-splitter part is divided into a first portion to the incident-surface side of the optically functional surface, and a second portion to the extension-part side of the optically functional surface; and
the extension part is formed integrally with said first portion.

11. The stereoscopic imaging device according to claim 2, wherein:
the beam-splitter part is divided into a first portion to the incident-surface side of the optically functional surface, and a second portion to the extension-part side of the optically functional surface; and
the extension part is formed integrally with said first portion.

12. The stereoscopic imaging device according to claim 2, wherein:
the beam-splitter part is divided into a first portion to the incident-surface side of the optically functional surface, and a second portion to the extension-part side of the optically functional surface; and
the extension part is formed integrally with said first portion.

13. A stereoscopic imaging device comprising:
an optical branching device having
a beam-splitter part including
an incident surface in the form of a rectangle having longer sides extending in a first direction and shorter sides extending in a second direction, and
an optically functional surface that passes a portion of light emitted from the incident surface in a third direction, orthogonal to the incident surface, and that, reflecting a remaining portion of the light emitted from the incident surface, bends the reflected light into the second direction; and
a reflection part for reflecting at least a portion of light bent by the beam splitter part and bending the reflected light into a third direction orthogonal to the incident surface;
a first camera arranged such that the optical axis of an optical system thereof is orthogonal to the incident surface, for taking an optical image having passed through the optically functional surface; and
a second camera arranged such that the optical axis of an optical system thereof is parallel to the optical axis of the optical system of the first camera, for taking an optical image reflected by the reflection part; wherein
one of either the first camera or the second camera is supported so as to be shiftable in said first direction.
